(19) United States
(12) Patent Application Publication
(10) Pub. No.: US 2009/0291179 A1
(43) Pub. Date: Nov. 26, 2009

(54) Method for producing high-protein soybean snack food

(76) Inventors: Yasuyuki Nakano, Izumisano-shi (JP); Tetsuo Sakata, Izumisano-shi (JP)

Correspondence Address: WENDEROTH, LIND & PONACK, L.L.P., 1030 15th Street, N.W.,, Suite 400 East, Washington, DC, 20005-1503, US

(21) Appl. No.: 12/308,988

(22) PCT Filed: Jul. 2, 2007
(86) PCT No.: PCT/JP2007/063219

§ 371 Date: Dec. 31, 2008

(30) Foreign Application Priority Data
Jul. 3, 2006 (JP) 2006-183825

(51) Int. Cl. A23L 1/305

(52) U.S. Cl. 426/506

(57) ABSTRACT

A high-protein soybean snack food which is excellent in moldability and melting in the mouth unlike a conventional expanding snack food mainly composed of starch is obtained. By using not undegraded separated soybean protein but hydrolyzed soybean protein as a main raw material and combining calcium carbonate therewith, adding water thereto, extruding and expanding the mixture by a high-temperature and high-pressure treatment with an extruder, a high-protein soybean snack food which is excellent in moldability and melting in the mouth can be produced.

### TECHNICAL FIELD

The present invention relates to a method for producing a high-protein soybean snack food excellent in meltability in the mouth with throat smoothness and moldability.

### BACKGROUND ART

In a conventional expanding snack food, carbohydrates such as starch are used as main raw material, and the expanding snack food is produced through a step of heating and pressurization by an extruder or a step of heating such as frying. However, since such an expanding snack food uses starch as main raw material, most of constituents are carbohydrates.

On the other hand, several methods for producing a snack food reinforced with protein have been known, however any production method of satisfying in meltability in the mouth with throat smoothness and moldability, which become problems when protein content is increased, has not been known.

For example, Patent Document 1 discloses that grains are expanded, and the surface of this expanded grain is coated with soybean powder together with fat to produce a protein-reinforced snack. However, according to examples, it is coated with only a few % of soybean powder, therefore it is not a reference for obtaining the desired snack of the present invention with high protein content.

Further, Patent Document 2 by the applicant of the present invention discloses a method for improving meltability in the mouth with throat smoothness by enzymatic degradation of soybean protein and the like. According to this technique, it becomes possible to add soybean protein to a certain amount, however, there is limitation for achieving higher level of an amount of soybean protein.

On the other hand, the present invention makes higher protein content, and meltability in the mouth with throat smoothness is further improved by using calcium carbonate in combination.

Meanwhile, Patent Document 3 discloses a high protein extrudate by combination of partially hydrolyzed soybean protein and carbohydrates. However, the document neither teaches using calcium carbonate in combination nor a high-protein soybean snack food excellent in meltability in the mouth with throat smoothness and moldability as in the present application.

Furthermore, Patent Document 4 discloses a snack which uses protein and starch as main raw material and which is obtained by mixing MgCO₃ with at least one selected from the group consisting of NaCl, KCl and CaCl₂ followed by expanding the mixture. However, examples disclose only 20% of separated (isolated) soybean protein, and the hydrolyzed soybean protein and calcium carbonate of the present invention are also not disclosed.

As apparent from the above, there is no teaching of a high-protein snack using calcium carbonate as in the present invention. In other words, a high-protein soybean snack food having high protein content and excellent in meltability in the mouth with throat smoothness and moldability is not disclosed.
Patent Document 1: JP 49-124243 A
Patent Document 2: JP 1-23857 A
Patent Document 3: US 2005-0220979 A1
Patent Document 4: JP 4-51849 A

### DISCLOSURE OF THE INVENTION

### Problems to be Solved by the Invention

An object of the present invention is to obtain a high-protein soybean snack food which is an expanding snack food containing soybean protein in a large amount, which is excellent in meltability in the mouth with throat smoothness and moldability, unlike a conventional expanding snack food mainly composed of starch.

### Means for Solving the Problems

The present inventors have intensively studied to solve the above-mentioned problems, and have found that by using not undegraded separated soybean protein which is usually used but hydrolyzed soybean protein as a main raw material and combining starch with calcium carbonate, adding water thereto, and extruding and expanding the mixture under high temperature and high pressure with an extruder, a high-protein soybean snack food excellent in meltability in the mouth with throat smoothness and moldability can be produced, and the present invention has been completed.

That is, the present invention relates to a method for producing a high-protein soybean snack food characterized in that hydrolyzed soybean protein, starch and calcium carbonate are pressurized and heated in an aqueous system, and the mixture is extruded and expanded. Hydrolysis ratio (anhydrous basis) of said hydrolyzed soybean protein is preferably 5 to 30%. Protein content (anhydrous basis) of the hydrolyzed soybean protein is preferably 60 to 97.5% by weight. Addition amount (anhydrous basis) of calcium is preferably 0.1 to 1.0% by weight based on the raw material solid for extrusion (anhydrous basis). Bulk specific gravity is preferably 0.05 to 0.40 g/ml.

### EFFECTS OF THE INVENTION

According to the present invention, a high-protein soybean snack food which is more excellent in meltability in the mouth with throat smoothness and moldability than a conventional product can be obtained.

### BEST MODE FOR CARRYING OUT THE INVENTION

The present invention relates to a method for producing a high-protein soybean snack food characterized in that hydrolyzed soybean protein, starch and calcium carbonate are pressurized and heated under aqueous system, and the mixture is extruded and expanded.

### (Hydrolyzed Soybean Protein)

Hydrolyzed soybean protein used in the present invention is preferably obtained by hydrolyzing defatted soybean milk, concentrated soybean protein, separated soybean protein or the like which is having protein content (anhydrous basis) of 60% or more, and made from soybean which is removed hull and hypocotyl, and defatted. Hydrolysis can be carried out by using known enzymes and acids.

Defatted soybean milk can be made into hydrolyzed powdery soybean milk by directly spray drying after enzyme degradation, and further, made into separated hydrolyzed powdery soybean milk by spray drying after further acid precipitation to remove whey. Further, defatted soybean slurry can be made into hydrolyzed concentrated protein by enzyme degradation followed by acid precipitation to remove whey, followed by drying. Furthermore, defatted soybean milk can be made into hydrolyzed separated soybean protein by acid precipitation to remove whey followed by enzyme degradation, and if necessary, followed by spray drying or the like.

An enzyme to be used is not particularly limited, and known proteolytic enzymes can be used. Conditions of the enzyme degradation are also not particularly limited, and the enzyme degradation can be carried out within a general 2/S ratio range in an acting temperature and acting pH region.

It is suitable that hydrolysis ratio (anhydrous basis) of hydrolyzed soybean protein as described above is 5 to 30%, preferably 7 to 27%, and further preferably 10 to 24%.

In addition, the hydrolysis ratio is indicated as TCA soluble ratio expressed by dividing trichloroacetic acid soluble nitrogen of final 0.22 M by total nitrogen and multiplying 100.

Using soybean protein with low hydrolysis ratio leads to extremely low effect of improving meltability in the mouth with throat smoothness of a high-protein soybean snack food. Too high hydrolysis ratio is not preferable since not only an obtained high-protein soybean snack food has bitter taste and thus not favorable in view of the flavor, but also uniform expanded shape is hardly maintained and thus the appearance is not good.

As described above, it is suitable that protein content (anhydrous basis) of the hydrolyzed soybean protein of the present invention is 60 to 97.5% by weight, preferably 70 to 97.5% by weight, and more preferably 80 to 97.5% by weight. Further, the protein content herein is calculated using a nitrogen coefficient of 6.25 by Kjeldahl method. In defatted soybean having low protein content, meltability in the mouth with throat smoothness are poor, and even when separated soybean protein degraded with an enzyme is used, it is hard to increase protein content exceeding 97.5% by weight.

The high-protein soybean snack food of the present invention can be obtained by pressurizing, heating, extruding and expanding the mixture of hydrolyzed soybean protein, starch and calcium carbonate.

It is suitable that an amount of the hydrolyzed soybean protein to be added is 97.5 to 60.0% by weight, preferably 95.0 to 65.0% by weight, and more preferably 92.5 to 70.0% by weight as a crude protein content on anhydrous basis in a raw material solid for extrusion.

When ratio of the hydrolyzed soybean protein is less than 60% by weight (anhydrous basis), the snack food is hardly said to be high in protein. When the ratio of the hydrolyzed soybean protein is more than 97.5 parts by weight (anhydrous basis), meltability in the mouth with throat smoothness of the high protein soybean snack food deteriorates.

For starch used in the present invention, raw materials containing at least one material selected from the group consisting of grains such as rice, wheat and corn; root crops; and potatoes; starch obtained therefrom; and physically and chemically treated products thereof such as crushed products, pregelatinized products, degraded products and the like; can be used. Tapioca starch, rice powder or the like are preferable because they can improve meltability in the mouth with throat smoothness of the high-protein soybean snack food.

It is suitable that an amount of starch to be added is 0.05 to 39.75% by weight on anhydrous basis in a raw material solid for extrusion, preferably 2.75 to 34.5% by weight, and more preferably 5.5 to 29.25% by weight. If the amount to be added is too large, it is hard for the high-protein soybean snack food to have a content of soybean protein of 60% by weight or more.

As others, saccharides such as glucose and fructose, disaccharides such as sugar and trehalose with less sweetness, oligosaccharides such as isomaltooligosaccharide, and other glucide can be used in combination. It is desirable that trehalose, isomaltooligosaccharide and the like are used in combination in view of flavor.

### (Calcium Carbonate)

Calcium carbonate of the present invention may be a commercially available general food additive, and for example, those having a content of calcium carbonate for a food additive of 98% or more (drying loss weight of 2% or less) can be used. Shell calcium and egg shell calcium containing calcium carbonate can be used in the same manner as the calcium carbonate.

Calcium compounds other than calcium carbonate, for example, calcium sulfate and calcium lactate are not preferable, because they have an action of lowering a pH to acidic side in a state of melting with low water under high temperature and high pressure as in the present invention, thus expansion of an extruded product is suppressed and texture is directed to become hard.

By using calcium carbonate as in the present invention, a pH is increased and expansion is enhanced, and at the same time, an expanded product containing fine air bubbles by Ca is generated, and thus, a high-protein soybean snack food with preferable meltability in the mouth can be obtained.

It is suitable that an amount of calcium carbonate to be added is 2.45 to 0.25% by weight (1.0 to 0.1% by weight as calcium) on anhydrous basis in a raw material solid for extrusion, preferably 2.25 to 0.5% by weight (0.9 to 0.2% by weight as calcium), and more preferably 2.0 to 0.75% by weight (0.8 to 0.3% by weight as calcium).

As a content of hydrolyzed soybean protein is increased, meltability in the mouth with throat smoothness deteriorates, however, by using calcium carbonate in combination, a tissue of an expanded product can be improved into fine, uniform air bubbles, and meltability in the mouth with throat smoothness can be improved. When the amount to be added is larger than 2.45 parts by weight, it is likely to feel an astringent taste. When calcium content is less than 0.1% (0.25% of calcium carbonate), an effect of improvement in meltability in the mouth with throat smoothness is insufficient.

The high-protein soybean snack food of the present invention can be obtained by pressurizing and heating the above described raw materials under aqueous system and extruding and expanding the mixture.

Moisture provided in an extruder is suitably 15 to 60% based on the raw materials, preferably 20 to 55%, and more preferably 25 to 50%. When more than 60% of water is added, expansion is insufficient. When less than 15% of water is added, it tends to generate heated odor and burnt deposit.

### (Extruder)

As a means for extruding and expanding the mixture, an extruder can be used.

As an extruder used in the present invention, known extruders can be used and a uniaxial extruder may be used, however, it is more suitable to use an extruder having two or more axes, which is powerful in kneading and can be easily organized with stability.

### (Expansion Conditions)

The expansion conditions in the present invention are not particularly limited, and can be experimentally determined depending on desired high-protein soybean snack food.

For example, it is suitable that a tip barrel temperature in the present invention can be set at 120 to 220° C., preferably 130 to 210° C., and more preferably 150 to 200° C. When the tip barrel temperature is too low, sufficient expansion is hardly obtained, and when the temperature is too high, there is a case of getting burned.

Extruded and expanded high-protein soybean snack food is cut into suitable size with a cutter, a pulverizer or the like, and then can be utilized as food.

Shape of the high-protein soybean snack food of the present invention is not particularly limited. In the case of eating as a snack food as it is, such shapes capable of being eaten by pinching with fingers as spherical shape, bale shape, flat shape, stick shape, hollow shape, star shape, and the like are preferable. Further, in the case of kneading into dough of millet cake, nutrient bar or the like for the purposes of nutrient addition, bulk adjustment, improvement in texture or the like, rice grain shape, pellet shape or the like is preferable. Furthermore, in the case of using for rice crackers for chazuke (rice with tea poured over it), floating ingredients for a soup, breakfast cereal and the like, small stick shape, cubic shape, ring shape or the like is preferable.

The high-protein soybean snack food of the present invention can be used by imparting water resistance by known techniques such as a fat with high melting point, sugar coating or the like. Further, the snack food can be flatted with pressure after extrusion according to need into small flat shape, and those sufficiently expanded and flatted with pressure can maintain crispness of texture as compared with those extruded and dried with suppressing a degree of the expansion for the purpose of enhancing a specific gravity.

Accordingly, shape of the high-protein soybean snack food can be freely selected depending on an intended use.

The high-protein soybean snack food can be freely seasoned by known methods according to need. For example, salt, powdery soy source, sodium glutamate or the like can be coated in suitable amount.

The high-protein soybean snack food of the present invention has texture of favorable meltability in the mouth with throat smoothness, and it is suitable that desirable range of expansion is 0.05 to 0.40 g/ml as bulk specific gravity, preferably 0.10 to 0.35 g/ml, and more preferably 0.15 to 0.30 g/ml. In addition, the bulk specific gravity is measured by the method shown in Examples.

Snack food becomes lighter as the bulk specific gravity is small, however, snack food with small bulk specific gravity is too bulky as a high-protein soybean snack food intended to be compact and conveniently eaten although there is no problem in terms of the texture. Further, Texture becomes harder as the bulk specific gravity is larger. A bulk specific gravity can be obtained by adjusting degree of expansion.

The bulk specific gravity can be controlled by adjusting pressurization conditions and heating conditions of an extruder, in addition to ratios of hydrolyzed soybean protein, starch, calcium carbonate, water and the like, which are used.

### EXAMPLES

Hereinafter, embodiments of the present invention will be described by way of Examples, the exemplification is naturally simply explanation; accordingly, Examples have no direct relationship with intension and denotation of the inventive concepts.

### Production Example 1

### Preparation of Hydrolyzed Soybean Protein

To 10 kg of low modified defatted soybean (made by Fuji Oil Co., Ltd.), 15-fold of water was added and the mixture was adjusted to pH 7.0 with 1N NaOH and stirred and extracted by using a Homomixer at room temperature for 1 hour, and then, bean curd refuse content was removed using a centrifugal machine (1000 g×10 minutes) to obtain defatted soybean milk. 1N HCl was added thereto, the mixture was adjusted to pH 4.5, protein component was precipitated at the isoelectric point, and the precipitate was recovered by centrifugation to obtain a separated soybean protein curd (hereinafter, referred to as “curd”). The curd was added with water so as to have a concentration of solid content of about 12% by weight, and neutralization was carried out to be a solution pH of 7.4 by using sodium hydroxide.

Then, an amount in use of an enzyme of “Alcalase 2.4L FG” (made by Novozymes A/S Co.) was adjusted and this neutralized protein solution was subjected to protein hydrolysis by adjusting reaction time at reaction temperature of 50° C. so as to have TCA soluble ratio as in the following Table 1. The resultant was subjected to heating treatment at 140° C. for 7 seconds using a direct heating sterilizer to obtain soybean protein solution.

After enzyme hydrolysis, this solution was dried by spraying to obtain powdery soybean protein.

### Examples 1 to 5 and Comparative Examples 1 and 2

### Production of High-Protein Soybean Snack Food

Water was continuously added to blended raw materials in following Table 1 and the amount thereof was adjusted, while adjusting a degree of expansion, the mixture was organized and expanded at a barrel setting temperature of 150° C., using a biaxial extruder (KEI-45-25 type, made by Kowa Kogyo Co., Ltd.).

The obtained expanded product was cut at a position right after the dice outlet by a rotational cutter so as to have length of about 5 mm, and dried by flowing hot air at 90° C. by a dryer made by ESPEC Corporation, so that moisture content was about 5% by weight to thereby obtain a high-protein soybean snack food.

Results of analysis and evaluation carried out on the high-protein soybean snack food thus obtained are shown in following Table 1.

TABLE 1

| Experiment | | Hydrolysis | Part by | | Product |
|---|---|---|---|---|---|
| No. | Raw materials | ratio % | weight | | name |
| Comparative | Undegraded | 3 | 90 | parts | Fujipro R |
| Example 1 | soybean protein | | | | |
| | Tapioca starch | | 9 | parts | |
| | Calcium | | 1 | part | |
| | carbonate | | | | |
| Example 1 | Hydrolyzed | 6 | 90 | parts | Sample A |
| | soybean protein | | | | |
| | Tapioca starch | | 9 | parts | |
| | Calcium | | 1 | part | |
| | carbonate | | | | |
| Example 2 | Hydrolyzed | 9 | 90 | parts | Sample B |
| | soybean protein | | | | |
| | Tapioca starch | | 9 | parts | |
| | Calcium | | 1 | part | |
| | carbonate | | | | |
| Example 3 | Hydrolyzed | 15 | 90 | parts | Sample C |
| | soybean protein | | | | |
| | Tapioca starch | | 9 | parts | |
| | Calcium | | 1 | part | |
| | carbonate | | | | |
| Example 4 | Hydrolyzed | 25 | 90 | parts | Sample D |
| | soybean protein | | | | |
| | Tapioca starch | | 9 | parts | |
| | Calcium | | 1 | part | |
| | carbonate | | | | |
| Example 5 | Hydrolyzed | 28 | 90 | parts | Sample E |
| | soybean protein | | | | |
| | Tapioca starch | | 9 | parts | |
| | Calcium | | 1 | part | |
| | carbonate | | | | |
| Comparative | Hydrolyzed | 33 | 90 | parts | Sample F |
| Example 2 | soybean protein | | | | |
| | Tapioca starch | | 9 | parts | |
| | Calcium | | 1 | part | |
| | carbonate | | | | |

Expansion degrees were corresponded so that all specific gravities were 0.25 g/ml.

TABLE 2

| Evaluation | | | |
|---|---|---|---|
| No. | Flavor | Texture | Moldability |
| Comparative | ◯: soybean | X: poor meltability | ⊙ |
| Example 1 | flavor | in the mouth with | |
| | | throat smoothness | |
| Example 1 | ◯: soybean | Δ: acceptable | ⊙ |
| | flavor | meltability in the | |
| | | mouth with throat | |
| | | smoothness | |
| Example 2 | ◯: soybean | Δ: acceptable | ⊙ |
| | flavor | meltability in the | |
| | | mouth with throat | |
| | | smoothness | |
| Example 3 | ◯: soybean | ◯: good meltability | ◯ |
| | flavor | in the mouth with | |
| | | throat smoothness | |
| Example 4 | ◯: soybean | ⊙: excellent | Δ |
| | flavor | meltability in the | |
| | | mouth with throat | |
| | | smoothness | |
| Example 5 | ◯: soybean | ⊙: excellent | Δ |
| | flavor | meltability in the | |
| | | mouth with throat | |
| | | smoothness | |
| Comparative | Δ: soybean | ⊙: excellent | X |
| Example 2 | flavor with | meltability in the | |
| | somewhat | mouth with throat | |
| | bitter taste | smoothness | |

⊙ Excellent,
◯ Good,
Δ Acceptable,
X Unacceptable

Effects on flavor, texture, and moldability due to hydrolysis ratio of soybean protein were confirmed.

At 3% of the hydrolysis ratio in Comparative Example 1, the flavor was a soybean flavor and good, the meltability in the mouth with throat smoothness was poor and unacceptable, and the moldability was excellent.

At 6% and 9% of the hydrolysis ratios in Examples 1 and 2, the flavor was a soybean flavor and good, the meltability in the mouth with throat smoothness was acceptable, and the moldability was excellent.

At 15% of the hydrolysis ratio in Example 3, the flavor was a soybean flavor and good, the meltability in the mouth with throat smoothness was good as well, and the moldability was also good.

At 25% and 28% of the hydrolysis ratios in Examples 4 and 5, the flavor was a soybean flavor and good, the meltability in the mouth with throat smoothness was excellent, but the moldability was acceptable.

Reaching the hydrolysis ratio of 33% in Comparative Example 2, the flavor was somewhat bitter, the meltability in the mouth with throat smoothness was excellent, but the moldability was unacceptable.

On the whole, hydrolysis ratio around that in Example 3 was preferable for 1 part by weight of calcium carbonate.

### Example 6 and Comparative Examples 3 to 7

### Comparative Experiments

Effects on flavor, texture, and moldability due to adding various calcium compounds and carbonic acid compounds were confirmed.

TABLE 3

| Experiment | | Hydrolysis | Part by | |
|---|---|---|---|---|
| No. | Raw materials | ratio % | weight | |
| Example 6 | Hydrolyzed | 15 | 90 | parts |
| | soybean protein | | | |
| | Tapioca starch | | 9 | parts |
| | Calcium | | 1 | part |
| | carbonate | | | |
| Comparative | Hydrolyzed | 15 | 90 | parts |
| Example 3 | soybean protein | | | |
| | Tapioca starch | | 9.26 | parts |
| | Calcium | | 0.74 | part |
| | hydroxide | | | |
| Comparative | Hydrolyzed | 15 | 90 | parts |
| Example 4 | soybean protein | | | |
| | Tapioca starch | | 8.64 | parts |
| | Calcium sulfate | | 1.36 | parts |
| Comparative | Hydrolyzed | 15 | 90 | parts |
| Example 5 | soybean protein | | | |
| | Tapioca starch | | 8.89 | parts |
| | Calcium chloride | | 1.11 | parts |
| Comparative | Hydrolyzed | 15 | 90 | parts |
| Example 6 | soybean protein | | | |
| | Tapioca starch | | 9 | parts |
| | Magnesium | | 1 | part |
| | carbonate | | | |
| Comparative | Hydrolyzed | 15 | 90 | parts |
| Example 7 | soybean protein | | | |
| | Tapioca starch | | 9 | parts |
| | Sodium hydrogen | | 1 | part |
| | carbonate | | | |

Expansion degrees were adjusted so that all specific gravities were 0.25 g/ml.
Calcium salt was adjusted so as to be 0.4 part as calcium.

TABLE 4

| Evaluation | | | |
|---|---|---|---|
| No. | Flavor | Texture | Moldability |
| Example 6 | ◯: soybean | ◯: good meltability | ◯ |
| | flavor | in the mouth with | |
| | | throat smoothness | |
| Comparative | Δ: soybean | ◯: good meltability | ◯ |
| Example 3 | flavor | in the mouth with | |
| | | throat smoothness | |
| Comparative | ◯: soybean | X: poor meltability | Δ |
| Example 4 | flavor | in the mouth with | |
| | | throat smoothness | |
| Comparative | ◯: soybean | Δ: acceptable | Δ |
| Example 5 | flavor | meltability in the | |
| | | mouth with throat | |
| | | smoothness | |
| Comparative | ◯: soybean | Δ: acceptable | Δ |
| Example 6 | flavor | meltability in the | |
| | | mouth with throat | |
| | | smoothness | |
| Comparative | ◯: soybean | Δ: acceptable | Δ |
| Example 7 | flavor | meltability in the | |
| | | mouth with throat | |
| | | smoothness | |

⊙ Excellent,
◯ Good,
Δ Acceptable,
X Unacceptable

In Example 6, calcium carbonate was added, and the flavor was soybean flavor and good, the meltability in the mouth with throat smoothness was good as well, and the moldability was also good.

In Comparative Example 3, calcium hydroxide was added, and the flavor was soybean flavor and good, the meltability in the mouth with throat smoothness was good as well, and the moldability was also good.

In Comparative Example 4, calcium sulfate was added, and the flavor was soybean flavor and good, however, the meltability in the mouth with throat smoothness was poor, and the moldability was acceptable.

In Comparative Example 5, calcium chloride was added, and the flavor was soybean flavor and good, however, the meltability in the mouth with throat smoothness was acceptable, and the moldability was also acceptable.

In Comparative Example 6, magnesium carbonate was added, and the flavor was soybean flavor and good, however, the meltability in the mouth with throat smoothness was acceptable, and the moldability was also acceptable.

In Comparative Example 7, sodium hydroxide was added, and the flavor was soybean flavor and good, however, the meltability in the mouth with throat smoothness was acceptable, and the moldability was also acceptable.

Example 6 and Comparative Example 3 had the same evaluation result, however, calcium carbonate was better than calcium hydroxide in view of workability and was slightly better in view of the flavor.

As described above, it was found that basically, a calcium compound that raises pH to alkaline side was preferable.

### Examples 7 to 9 and Comparative Examples 8 and 9

### Comparative Experiments

Effects on flavor, texture, and moldability due to addition ratio of calcium carbonate were confirmed.

TABLE 5

| Experiment | | Hydrolysis | Part by | |
|---|---|---|---|---|
| No. | Raw materials | ratio % | weight | |
| Comparative | Hydrolyzed | 15 | 90 | parts |
| Example 8 | soybean protein | | | |
| | Tapioca starch | | 9.8 | parts |
| | Calcium | | 0.2 | part |
| | carbonate | | | |
| Example 7 | Hydrolyzed | 15 | 90 | parts |
| | soybean protein | | | |
| | Tapioca starch | | 9.5 | parts |
| | Calcium | | 0.5 | part |
| | carbonate | | | |
| Example 8 | Hydrolyzed | 15 | 90 | parts |
| | soybean protein | | | |
| | Tapioca starch | | 8.5 | parts |
| | Calcium | | 1.5 | parts |
| | carbonate | | | |
| Example 9 | Hydrolyzed | 15 | 90 | parts |
| | soybean protein | | | |
| | Tapioca starch | | 8 | parts |
| | Calcium | | 2 | parts |
| | carbonate | | | |
| Comparative | Hydrolyzed | 15 | 90 | parts |
| Example 9 | soybean protein | | | |
| | Tapioca starch | | 7 | parts |
| | Calcium | | 3 | parts |
| | carbonate | | | |

Expansion degrees were corresponded so that all specific gravities were 0.25 g/ml.

TABLE 6

| Evaluation | | | |
|---|---|---|---|
| No. | Flavor | Texture | Moldability |
| Comparative | ◯: soybean | Δ: acceptable | Δ |
| Example 8 | flavor | meltability in the | |
| | | mouth with throat | |
| | | smoothness | |
| Example 7 | ◯: soybean | Δ: acceptable | ◯ |
| | flavor | meltability in the | |
| | | mouth with throat | |
| | | smoothness | |
| Example 8 | ◯: soybean | ⊙: excellent | ⊙ |
| | flavor | meltability in the | |
| | | mouth with throat | |
| | | smoothness | |
| Example 9 | ◯: soybean | ⊙: excellent | ⊙ |
| | flavor | meltability in the | |
| | | mouth with throat | |
| | | smoothness | |
| Comparative | Δ: soybean | ⊙: excellent | ⊙ |
| Example 9 | flavor with | meltability in the | |
| | astringent | mouth with throat | |
| | taste | smoothness | |

⊙ Excellent,
◯ Good,
Δ Acceptable,
X Unacceptable

In Comparative Example 8, 0.2 part by weight of calcium carbonate was added, and a product of which the flavor was soybean flavor and good, the meltability in the mouth with throat smoothness was acceptable, and the moldability was acceptable was obtained.

In Example 7, 0.5 part by weight of calcium carbonate was added, and a product of which the flavor was soybean flavor and good, the meltability in the mouth with throat smoothness was acceptable, and the moldability was good was obtained.

In Example 8, 1.5, parts by weight of calcium carbonate was added, and a product of which the flavor was soybean flavor and good, the meltability in the mouth with throat smoothness was excellent, and the moldability was also excellent was obtained.

In Example 9, 2.0 parts by weight of calcium carbonate was added, and a product of which the flavor was soybean flavor and good, the meltability in the mouth with throat smoothness was excellent, and the moldability was also excellent was obtained.

In Comparative Example 9, 3.0 parts by weight of calcium carbonate was added, and a product of which the flavor was soybean flavor and some astringent taste was felt, the meltability in the mouth with throat smoothness was excellent, and the moldability was also excellent was obtained.

As described above, it was found that addition ratio of calcium carbonate was good at around the addition ratios in Examples 8 and 9 in view of flavor, texture, and moldability.

### Examples 10 to 12 and Comparative Examples 10 and 11

A tendency of texture was confirmed on a product of blending of Example 8 in which expansion was adjusted and a bulk specific gravity was varied.

TABLE 7
Regarding comparison between texture and bulk specific gravity

| Evaluation | | Bulk specific | Compact |
|---|---|---|---|
| No. | Texture | gravity (g/ml) | property |
| Comparative | X: poor meltability | 0.43 | ⊙ |
| Example 10 | in the mouth with | | |
| | throat smoothness | | |
| Example 10 | ◯: good meltability | 0.36 | ◯ |
| | in the mouth with | | |
| | throat smoothness | | |
| Example 11 | ⊙: excellent | 0.25 | ◯ |
| | meltability in the | | |
| | mouth with throat | | |
| | smoothness | | |
| Example 12 | ⊙: excellent | 0.13 | Δ |
| | meltability in the | | |
| | mouth with throat | | |
| | smoothness | | |
| Comparative | ⊙: excellent | 0.04 | X |
| Example 11 | meltability in the | | |
| | mouth with throat | | |
| | smoothness | | |

⊙ Excellent,
◯ Good,
Δ Acceptable,
X Unacceptable

Note) Sample bulk specific gravity (g/ml) was calculated by measuring weight (W) of a sample when 500 ml of the sample was filled in a 0.500 ml-measuring flask and using the following formula.

Sample bulk specific gravity(g/ml)=W(g)/500(ml).

In Comparative Example 10, the bulk specific gravity was as large as 0.43 (g/ml), the texture was firm, and the meltability in the mouth with throat smoothness was poor and unacceptable. However, the compact property was excellent.

In Example 10, the bulk specific gravity was somewhat large as 0.36 (g/ml), however, the meltability in the mouth with throat smoothness was good, and the compact property was excellent.

In Example 11, the bulk specific gravity was 0.25 (g/ml), the meltability in the mouth with throat smoothness was excellent, and the compact property was excellent.

In Example 12, the bulk specific gravity was 0.13 (g/ml), the meltability in the mouth with throat smoothness was excellent, and the compact property was acceptable although being somewhat bulky.

In Comparative Example 11, the bulk specific gravity was as small as 0.04 (g/ml), the meltability in the mouth with throat smoothness was excellent, however, the obtained product was too bulky and thus not suitable as a high-protein soybean snack food for the purpose of having a compact size and being conveniently eaten.

### INDUSTRIAL APPLICABILITY

It is found out that a method for producing a high-protein soybean snack food excellent in meltability in the mouth with throat smoothness and moldability is obtained according to the present invention. Recently, for the purpose of diet, protein supplement and the like, a high-protein soybean snack food in which lipid and carbohydrates are reduced is desired. The high-protein soybean snack food of the present invention will satisfy the desire.

1. A method for producing a high-protein soybean snack food, characterized in that hydrolyzed soybean protein, starch and calcium carbonate are pressurized and heated under aqueous system, and the mixture is extruded and expanded.

2. The production method according to claim 1, wherein hydrolysis ratio (anhydrous basis) of the hydrolyzed soybean protein is 5 to 30%.

3. The production method according to claim 1, wherein protein content (anhydrous basis) of the hydrolyzed soybean protein is 60 to 97.5% by weight.

4. The production method according to claim 1, wherein addition amount (anhydrous basis) of calcium is 0.1 to 1.0% by weight based on a raw material solid for extrusion (anhydrous basis).

5. The production method according to claim 1, wherein a bulk specific gravity of the high-protein soybean snack food is 0.05 to 0.40 g/ml.
